(19) United States
(12) Patent Application Publication
(10) Pub. No.: US 2019/0094781 A1
(43) Pub. Date: Mar. 28, 2019

(54) IMAGE FORMING APPARATUS TO AND FROM WHICH CONTAINER CONTAINING DEVELOPER CAN BE MOUNTED AND REMOVED

(71) Applicant: CANON KABUSHIKI KAISHA, Tokyo (JP)

(72) Inventors: Hiroyuki Eda, Moriya-shi (JP); Ryou Sakaguchi, Toride-shi (JP); Toshifumi Oikawa, Tsukubamirai-shi (JP)

(21) Appl. No.: 16/140,644

(22) Filed: Sep. 25, 2018

(30) Foreign Application Priority Data
Sep. 28, 2017 (JP) 2017-188361

(51) Int. Cl. G03G 15/00; G03G 15/16; G03G 15/08

(52) U.S. Cl. CPC G03G 15/553; G03G 15/0865; G03G 15/16; G03G 15/5016

(57) ABSTRACT

An image forming apparatus prevents a situation in which in place of a container in which developer remains, a container other than the container is mounted. A toner bottle containing developer to be replenished to the developing device is mounted to a toner replenishment section. A sensor detects amount of developer in the developing device, and in a case where the detected amount of the developer is smaller than a predetermined amount, a first screen for prompting a user to replace the toner bottle is displayed. In a case where the toner bottle is removed without determining that the toner bottle satisfies a replacement condition, a second screen for prompting the user to remount the removed toner bottle is displayed. In a case where the detected amount of the developer is smaller than the predetermined amount while the second screen is displayed, the second screens continues to be displayed.

### BACKGROUND OF THE INVENTION

### Field of the Invention

The present invention relates to an image forming apparatus to and from which a container containing developer can be mounted and removed.

### Description of the Related Art

An electrophotographic image forming apparatus forms an image by developing an electrostatic latent image formed on a photosensitive member by using developer in a developing device. There is a limit to the amount of developer which can be contained in the developing device, and hence developer is replenished from a container which can be mounted to and removed from the image forming apparatus, to the developing device as required.

The amount of developer in the container is also limited, and hence when developer in the container runs out, the developer cannot be replenished from the container to the developing device. Then, in a case where the amount of developer is continuously reduced without replenishing the developer to the developing device, the image forming apparatus notifies a user of the necessity of replacement of the container. Further, an image forming apparatus is also known which is capable of continuing the image forming operation even in a state in which the container has been removed. That is, the user can replace the container without interrupting the image forming operation.

However, a user sometimes replaces a container even though a predetermined amount or more of developer remains in the container. To prevent such an inconvenience, Japanese Laid-Open Patent Publication (Kokai) No. 2006-71905 proposes an image forming apparatus which displays, in a case where the container is removed before it becomes empty, a message (warning message) on a screen so as to notify a user that developer remains in the container. According to the image forming apparatus described in Japanese Laid-Open Patent Publication (Kokai) No. 2006-71905, since the user is notified that the container can still be used, it is possible to suppress replacement of a container in which developer remains.

Let it be assumed that an image forming apparatus capable of replacing the container even during image formation displays a message (warning message) on a screen when the container is removed before it becomes empty, as in the case of the image forming apparatus described in Japanese Laid-Open Patent Publication (Kokai) No. 2006-71905. In this case, however, if the amount of developer in the developing device is continuously reduced without the user mounting the container having been once removed again, another message (replacement message) for prompting the user to mount a new container is displayed on the screen in place of the warning message. As a result, there is a possibility that the user mounts a new container to the image forming apparatus even though the developer remains in the container having been removed.

### SUMMARY OF THE INVENTION

The present invention provides an image forming apparatus that prevents a situation in which in place of a container in which developer remains, a container other than the container is mounted.

The present invention provides an image forming apparatus comprising an image forming unit including a developing device that contains developer and configured to form an image using the developer in the developing device, a portion to which a container is mountable, the container containing developer to be replenished to the developing device, a replenishment unit configured to replenish developer in the developing device from the container mounted to the portion, a sensor that detects an amount of the developer in the developing device, a display configured to display a first screen for prompting a user to replace the container mounted to the portion, in a case where an amount of the developer, detected by the sensor, is smaller than a predetermined amount, and a determination unit configured to determine whether or not the container mounted to the portion satisfies a replacement condition, wherein in a case where the container mounted to the portion is removed while the replacement condition is not satisfied, the display displays a second screen for prompting the user to remount the removed container, and wherein in a case where the amount of the developer, detected by the sensor, is smaller than the predetermined amount while the second screen is displayed, the display continues to display the second screen.

According to the present invention, it is possible to prevent a situation in which in place of the container in which developer remains, a container other than the container is mounted.

Further features of the present invention will become apparent from the following description of exemplary embodiments (with reference to the attached drawings).

### BRIEF DESCRIPTION OF THE DRAWINGS

FIG. 1 is a schematic cross-sectional view of an image forming apparatus.

FIG. 2 is a view of the appearance of a toner bottle.

FIG. 3 is a schematic diagram of a toner replenishment section.

FIG. 4 is a control block diagram of the image forming apparatus.

FIGS. 5A to 5C are diagrams showing how toner sensors detect toner.

FIGS. 6A and 6B are timing diagrams useful in explaining processing for determining absence of toner in the toner bottle and a toner conveying path, respectively.

FIG. 7 is a diagram showing an example of a replaceable state-notifying screen.

FIG. 8 is a diagram showing an example of a replacement prompting screen.

FIG. 9 is a diagram showing an example of a warning screen.

FIGS. 10A and 10B are diagrams showing changes of a screen in a conventional image forming apparatus and the image forming apparatus according to the present embodiment, respectively.

FIG. 11 is a flowchart of a warning screen-displaying process.

FIG. 12 is a flowchart of a replacement prompting screen-displaying process.

### DESCRIPTION OF THE EMBODIMENTS

The present invention will now be described in detail below with reference to the accompanying drawings showing embodiments thereof.

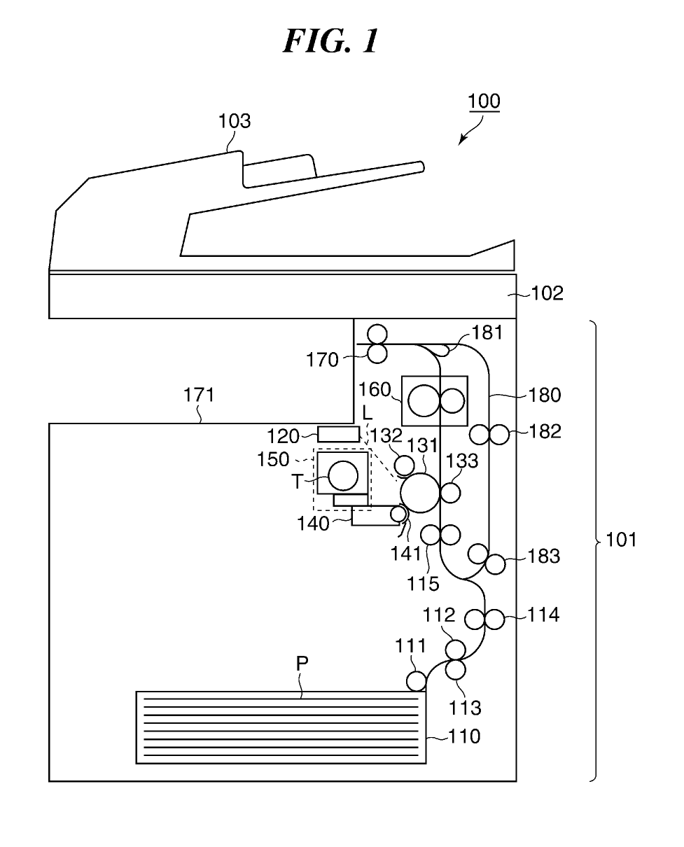

FIG. 1 is a schematic cross-sectional view of an image forming apparatus according to an embodiment of the present invention. This image forming apparatus, denoted by reference numeral 100, is comprised of a printer 101 that performs image formation on a sheet, a reader 102 that reads an image on an original, and an ADF unit 103 that conveys an original to be read. Note that a sheet on which an image is formed may be referred to as a recording sheet, a recording material, a recording medium, a paper, a transfer member, a transfer paper, or the like.

In the printer 101, recording sheets P accommodated in a sheet feed cassette 110 are fed to a conveying path, one by one, by a pickup roller 111, a sheet feed roller 112, and a retard roller 113. A recording sheet P fed from the sheet feed cassette 110 is conveyed along the conveying path by a conveying roller 114. When the recording sheet P reaches a position of a registration roller 115, skew correction is performed by the registration roller 115 having stopped its rotation. After that, the registration roller 115 starts to rotate, whereby the recording sheet P is conveyed to a transfer nip portion between a photosensitive drum 131 (photosensitive member) and a transfer roller 133.

The printer 101 as an image forming unit includes a laser scanner 120, the photosensitive drum 131, a charge roller 132, the transfer roller 133, and a developing device 140. The printer 101 forms an image on a recording sheet P. In the printer 101, an outer peripheral surface of the photosensitive drum 131 which is driven for rotation is uniformly charged to a potential having a predetermined polarity by an action of the charge roller 132. The laser scanner 120 exposes the charged photosensitive drum 131 to a light beam (laser beam). Specifically, the laser scanner 120 emits a laser beam L modulated according to image information (time-series digital pixel signal) to scan the charged photosensitive drum 131 with the laser beam L and thereby form an electrostatic latent image on the photosensitive drum 131. Note that the laser scanner 120 emits the laser beam L based on image data (image information) obtained by the reader 102 which reads an image on an original or image data received from an external apparatus, such as a PC, via a network.

The developing device 140 accumulates developer. A toner bottle T as a container can be mounted to and removed from a toner replenishment section 150. The toner replenishment section 150 functions as a portion to which the toner bottle T is mountable. The developing device 140 includes a developing roller 141, and develops an electrostatic latent image on the photosensitive drum 131 using toner supplied (replenished) from the toner replenishment section 150 to thereby form a toner image. To form a toner image, toner corresponding to image data is discharged from the developing device 140. The toner image formed on the photosensitive drum 131 is moved to the transfer nip portion in accordance with rotation of the photosensitive drum 131. A transfer bias having an opposite polarity to the polarity of the photosensitive drum 131 is applied to the transfer roller 133, and the toner image on the photosensitive drum 131 is transferred onto a surface of the recording sheet P at the transfer nip portion.

In the printer 101, the recording sheet P onto which the toner image has been transferred is conveyed into a fixing device 160. The fixing device 160 applies heat and pressure to the recording sheet P using a fixing heater and a pressure roller to thereby fix the toner image on the recording sheet P to the recording sheet P. The recording sheet P on which the image has been thus formed passes through the fixing device 160, and then is discharged (output) onto a discharge tray 171 outside the apparatus, by a discharge roller 170.

Further, in a case where double-sided printing is performed on a recording sheet P, the recording sheet P on which image formation on a first side thereof is completed is conveyed by the discharge roller 170 in a reverse direction after passing the position of an inversion flapper 181, and is then guided to an inversion conveying path 180 by the inversion flapper 181. The recording sheet P guided to the inversion conveying path 180 is conveyed to a position of the registration roller 115 again by conveying rollers 182 and 183. At this time, the recording sheet P is in a state in which the first side and the second side are inverted, compared with the case of image formation on the first side. After that, similar to the above-described image formation on the first side, image formation is performed on the second side, and then, the recording sheet P is discharged onto the discharge tray 171.

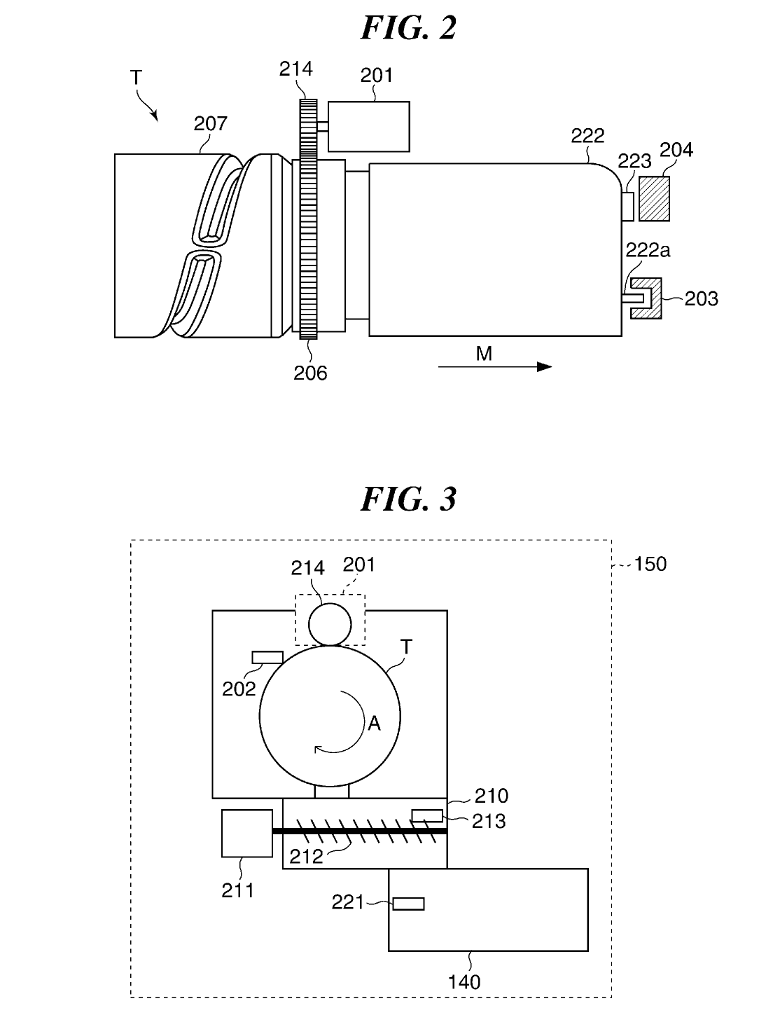

FIG. 2 is a view of the appearance of the toner bottle T mounted to the toner replenishment section 150 of the image forming apparatus 100. The toner bottle T includes a cap part 222, a container part 207 for storing toner, a driving transmission section 206 to which a rotational drive force from a bottle motor 201 is transmitted, and a discharge port (not shown) for discharging toner. The cap part 222 has a protrusion 222a formed in a far side in a direction of mounting the toner bottle T (direction indicated by an arrow M). A bottle sensor 203 provided in the image forming apparatus 100 detects the protrusion 222a of the cap part 222, and outputs a signal indicating that the toner bottle T is mounted, upon detection of the protrusion 222a. Further, a memory 223 which has recorded information concerning the toner bottle T is attached to the cap part 222.

FIG. 3 is a schematic diagram of the toner replenishment section 150 of the image forming apparatus 100. The toner bottle T which is filled with toner in advance is set to the toner replenishment section 150 by a user. The toner replenishment section 150 includes the toner bottle T, the bottle motor 201, a toner conveying path 210, and a conveying path motor 211. The toner conveying path 210 functions as a buffer for temporarily accumulating toner discharged from the toner bottle T. The toner conveying path 210 is part of the developing device 140 as well.

The driving transmission section 206 (see FIG. 2) of the toner bottle T is connected to the bottle motor 201 via a drive gear train 214, and a rotational drive force is applied from the bottle motor 201 to the driving transmission section 206. When the bottle motor 201 rotates, the toner bottle T is rotated in a direction indicated by an arrow A. When the toner bottle T is rotated, toner is discharged from the inside of the toner bottle T, and flows into the toner conveying path 210. A screw 212 is provided in the toner conveying path 210. A rotational shaft of the screw 212 is connected to the conveying path motor 211 via a drive gear train (not shown), and a rotational drive force is applied from the conveying path motor 211 to the rotational shaft of the screw 212 via the drive gear train. By rotating the screw 212, toner flowing into the toner conveying path 210 is conveyed in one direction (from left to right as viewed in FIG. 3). Toner conveyed through the toner conveying path 210 is replenished to the developing device 140 from an end portion of the toner conveying path 210. The bottle motor 201 and the conveying path motor 211 correspond to a replenishing unit of the present invention.

The toner replenishment section 150 includes an HP sensor 202 as a bottle home position sensor and a second toner sensor 213 as a second sensor. The HP sensor 202 is a sensor for detecting a position used as a reference (home position) of rotation of the toner bottle T, and is used for controlling rotation of the toner bottle T. The second toner sensor 213 is disposed in the toner conveying path 210. Further, a first toner sensor 221 as a first sensor for detecting presence or absence of toner in the developing device 140 is disposed in the developing device 140.

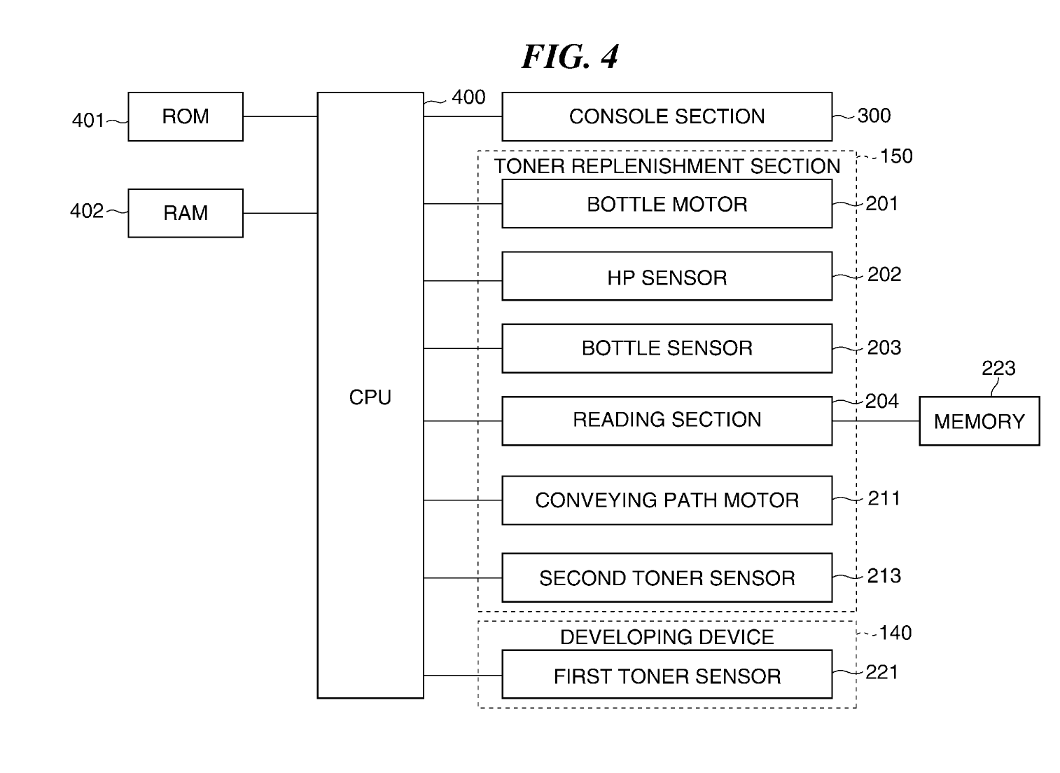

FIG. 4 is a control block diagram of the image forming apparatus 100. The image forming apparatus 100 includes a CPU 400, a ROM 401, and a RAM 402. The ROM 401 stores a control program for controlling the overall operation of the image forming apparatus 100. The RAM 402 is a volatile storage device, which is used as a work area for the CPU 400, and is also used as an area for temporarily storing various data, such as image data. The CPU 400 controls the overall operation of the image forming apparatus 100 by loading the control program stored in the ROM 401 into the RAM 402, and executing the same.

The CPU 400 controls the operation of the toner replenishment section 150 by controlling the operations of the bottle motor 201 and the conveying path motor 211. Input to the CPU 400 are respective signals output from the HP sensor 202, the bottle sensor 203, and the second toner sensor 213 of the toner replenishing section 150, and a signal output from the first toner sensor 221 of the developing device 140.

A reading section 204 (see FIG. 2) reads “replenishment information” recorded in the memory 223 of the toner bottle T mounted to a mounting location in the image forming apparatus 100 (i.e. to the toner replenishment section 150), and notifies the CPU 400 of the read information. Further, the reading section 204 can write the replenishment information notified from the CPU 400 into the memory 223 of the toner bottle T. The above-mentioned replenishment information includes e.g. the serial number of the toner bottle T, history of replenishment by the toner bottle T, and information indicative of a result of determination of whether or not the toner bottle T is “empty”. Note that the history of replenishment by the toner bottle T refers e.g. to the number of times of rotation of the toner bottle T. The CPU 400 causes the reading section 204 to record information on the number of times of rotation of the toner bottle T in the memory 223 whenever the CPU 400 causes the toner bottle T to make one rotation. The number of times of rotation of the toner bottle T corresponds to the number of times of replenishment from the toner bottle T.

A console section 300 includes a touch panel (screen) as a display section. The touch panel of the console section 300 displays a home screen, a replacement prompting screen, a warning screen, and so forth, according to respective associated signals delivered from the CPU 400. Further, the touch panel notifies the user of a state of the image forming apparatus 100 according to a signal delivered from the CPU 400. Further, in a case where a predetermined time period elapses without any user's operation on the touch panel of the console section 300, the CPU 400 reduces the brightness of the touch panel of the console section 300, thereby causing the image forming apparatus 100 to enter a low power mode, except for some cases. Note that the above-mentioned screens is not necessarily required to be displayed on the touch panel, but may be displayed, for example, on a monitor of a PC communicably connected to the image forming apparatus 100 via a network.

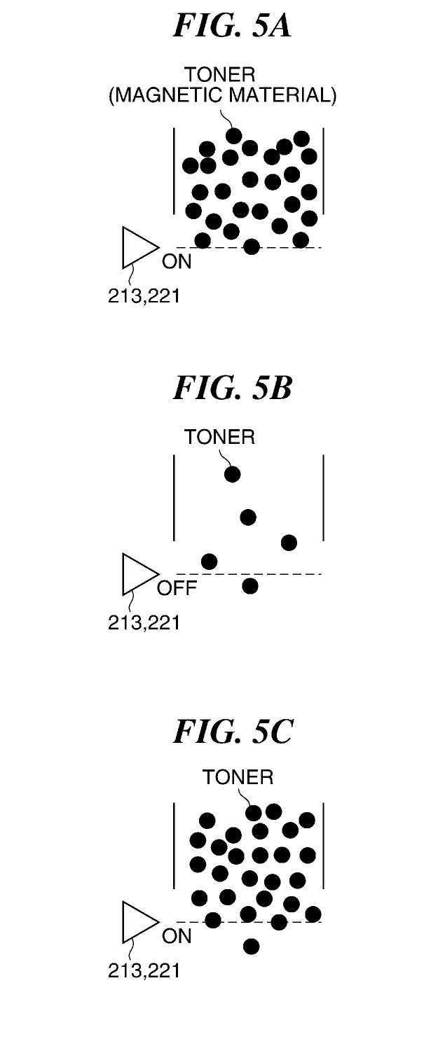

Next, a description will be given of processing for detecting presence or absence of toner, performed by the first toner sensor 221 and the second toner sensor 213, with reference to FIGS. 5A to 5C. FIGS. 5A to 5C are diagrams showing how the toner sensors 221 and 213 detect toner which is moving. The second toner sensor 213 disposed in the toner conveying path 210 and the first toner sensor 221 disposed in the developing device 140 are both magnetic permeability sensors. As shown in FIGS. 5A and 5C, the toner sensors 221 and 213 each output a signal indicative of an ON state in a case where toner containing a magnetic material is detected, and as shown in FIG. 5B, the toner sensors 221 and 213 each output a signal indicative of an OFF state in a case where the toner is not detected. That is, the toner sensors 221 and 213 each output a signal indicative of whether or not toner is detected.

Here, the first toner sensor 221 is disposed at a predetermined height from a bottom surface of the developing device 140 in a gravity direction. Therefore, in a case where the first toner sensor 221 detects toner, not less than a predetermined amount of toner is accumulated in the developing device 140. Further, the second toner sensor 213 is disposed at a predetermined height from a bottom surface of the toner conveying path 210 in the gravity direction. Therefore, in a case where the second toner sensor 213 detects toner, not less than a predetermined amount of toner is accumulated in the toner conveying path 210. Note that the height from the bottom surface of the developing device 140 to the first toner sensor 221 and the height from the bottom surface of the toner conveying path 210 to the second toner sensor 213 may be determined as appropriate.

In the present embodiment, the CPU 400 determines presence or absence of toner in the toner conveying path 210 and the developing device 140 by monitoring signals output from the second toner sensor 213 and the first toner sensor 221 at time intervals of 100 msec. In a case where toner is not detected by the second toner sensor 213 consecutively a predetermined number of times, the CPU 400 determines that there is no toner in the toner conveying path 210. This is a case where the signal output from the second toner sensor 213, which is acquired at the monitoring intervals, continuously indicates the OFF state the predetermined number of times, and hence is a case where the output from the second toner sensor 213 indicates a detection result of “absence of toner in the toner conveying path 210”. Similarly, in a case where toner is not detected by the first toner sensor 221 consecutively a predetermined number of times, the CPU 400 determines that there is no toner in the developing device 140. This is a case where the signal output from the first toner sensor 221, which is acquired at the monitoring intervals, continuously indicates the OFF state the predetermined number of times, and hence is a case where the output from the first toner sensor 221 indicates a detection result of “absence of toner in the developing device 140”.

Note that the above-described toner presence/absence detection processing is an example, and another processing may be employed. Further, a configuration may be employed in which piezo sensors are applied to the toner sensors 221 and 213 for detecting presence or absence of toner.

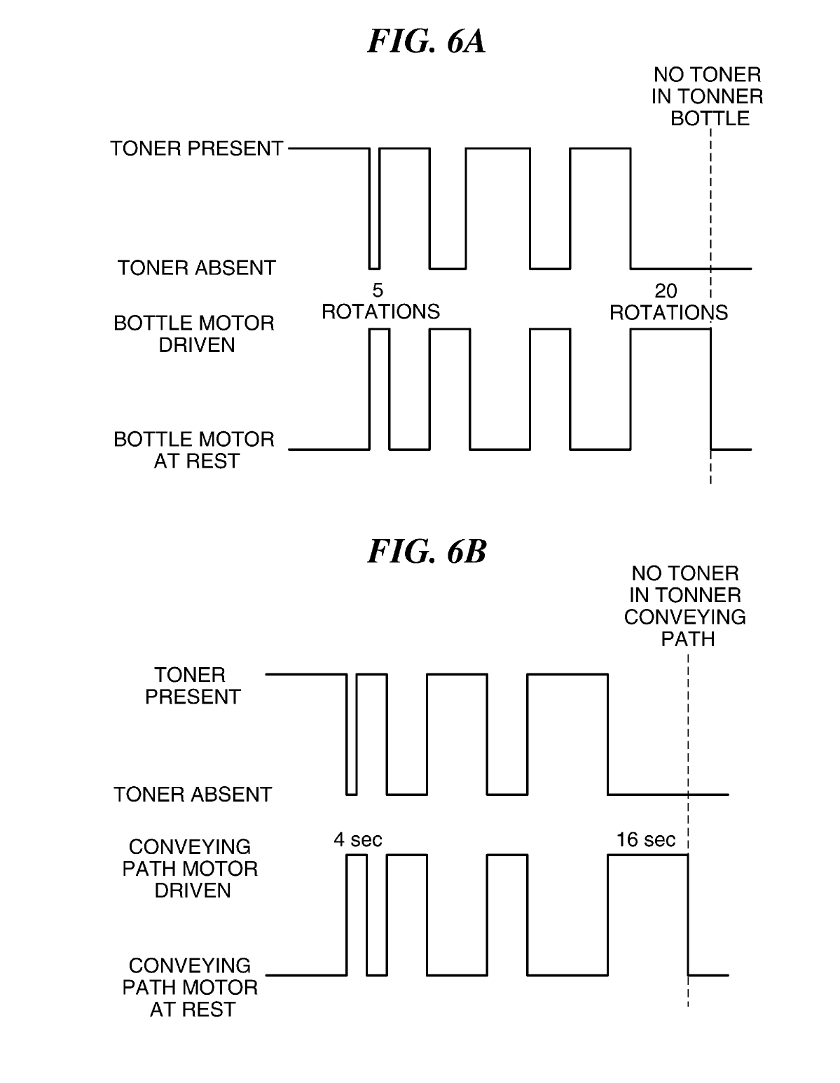

FIG. 6A is a timing diagram useful in explaining processing for determining absence of toner in the toner bottle T. The processing for determining whether or not toner in the toner bottle T has run out will be described with reference to FIG. 6A. As described above, during image formation, toner is discharged from the developing device 140 according to image data. If it is determined that there is no toner in the developing device 140, toner is replenished from the toner conveying path 210 to the developing device 140. Then, if replenishment of toner from the toner conveying path 210 to the developing device 140 is repeated, it is eventually determined, based on a result of the detection by the second toner sensor 213 in the toner conveying path 210, that there is no toner in the toner conveying path 210.

When it is determined that there is no toner in the toner conveying path 210, the CPU 400 causes the bottle motor 201 to rotate the toner bottle T. If this causes toner to be properly replenished from the toner bottle T to the toner conveying path 210, the detection result output from the second toner sensor 213 is changed to presence of toner in the toner conveying path 210. That is, the CPU 400 controls the bottle motor 201 so as to cause an appropriate amount of toner to be maintained in the toner conveying path 210. In the illustrated example in FIG. 6A, by causing the toner bottle T to make e.g. five rotations, the detection result output from the second toner sensor 213 is changed from absence of toner to presence of toner.

Here, if the amount of toner in the toner bottle T becomes not larger than a predetermined amount, despite rotation of the toner bottle T, no toner is replenished into the toner conveying path 210 any longer. As shown in FIG. 6A, in a case where the absence of toner in the toner conveying path 210 continues to be detected despite 20 rotations of the toner bottle T, the CPU 400 determines that the toner in the toner bottle T (in the toner container) has run out. Based on this determination, it is determined that the toner bottle T mounted to the toner replenishment section 150 satisfies a replacement condition. Note that an operation of causing the toner bottle T to make 20 rotations corresponds to a predetermined replenishment operation for replenishing toner from the attached toner bottle T to the toner conveying path 210. Therefore, in a case where the output from the second toner sensor 213 indicates a detection result of absence of toner in the toner conveying path 210, if the output from the second toner sensor 213 is not changed even after the predetermined replenishment operation is performed, it is determined that the toner in the toner bottle T has run out. Then, the CPU 400 writes information indicative of absence of toner in the toner bottle T into the memory 223 of the toner bottle T. Note that the number of rotations of the toner bottle T in the predetermined replenishment operation is not limited to 20.

Incidentally, the second toner sensor 213 detects presence or absence of toner in the toner conveying path 210 based on a reference amount. Therefore, even when it is determined that there is no toner in the toner conveying path 210, this does not necessarily mean that the amount of toner in the toner conveying path 210 has been reduced to zero. Therefore, even after the absence of toner in the toner bottle T is determined, it is possible to continue the image forming operation insofar as toner remains in the toner conveying path 210 although the remaining amount is not larger than the predetermined amount.

FIG. 6B is a timing diagram useful in explaining processing for determining absence of toner in the toner conveying path 210. As described above, during image formation, toner is discharged from the developing device 140 according to image data. The first toner sensor 221 detects presence or absence of toner in the developing device 140 based on a reference amount. When discharge of toner from the developing device 140 causes the amount of toner remaining therein to be smaller than the reference amount, the first toner sensor 221 outputs a signal indicative of the OFF state. When the output from the first toner sensor 221 thus indicates a detection result of absence of toner in the developing device 140, the CPU 400 causes the conveying path motor 211 to rotate the screw 212. For example, the CPU 400 drives the conveying path motor 211 for rotation for four seconds. This operation corresponds to a predetermined replenishment operation for replenishing toner from the toner conveying path 210 to the developing device 140. Note that the time period over which the conveying path motor 211 is driven is not limited to four seconds.

When toner is properly replenished to the developing device 140, the output from the first toner sensor 221 is changed to a detection result of presence of toner in the developing device 140. Thus, the CPU 400 controls the conveying path motor 211 so as to cause not less than a predetermined amount (reference amount) of toner to be maintained in the developing device 140. In FIG. 6B, by driving the conveying path motor 211 for rotation for four seconds, the detection result output from the first toner sensor 221 is changed from absence of toner to presence of toner.

Further, when the toner in the toner conveying path 210 has run out, even when the conveying path motor 211 is driven for rotation, no toner is replenished to the developing device 140 any longer. As shown in FIG. 6B, even when the conveying path motor 211 is driven for rotation for e.g. 16 seconds, the absence of toner in the developing device 140 is continuously detected. In this case, the CPU 400 determines that the toner in the toner conveying path 210 (in the buffer) has run out. Therefore, in a case where the output from the first toner sensor 221 indicates a detection result of absence of toner in the developing device 140, if the output from the first toner sensor 221 is not changed even after the above-mentioned predetermined replenishment operation is performed, it is determined that the toner in the toner conveying path 210 has run out.

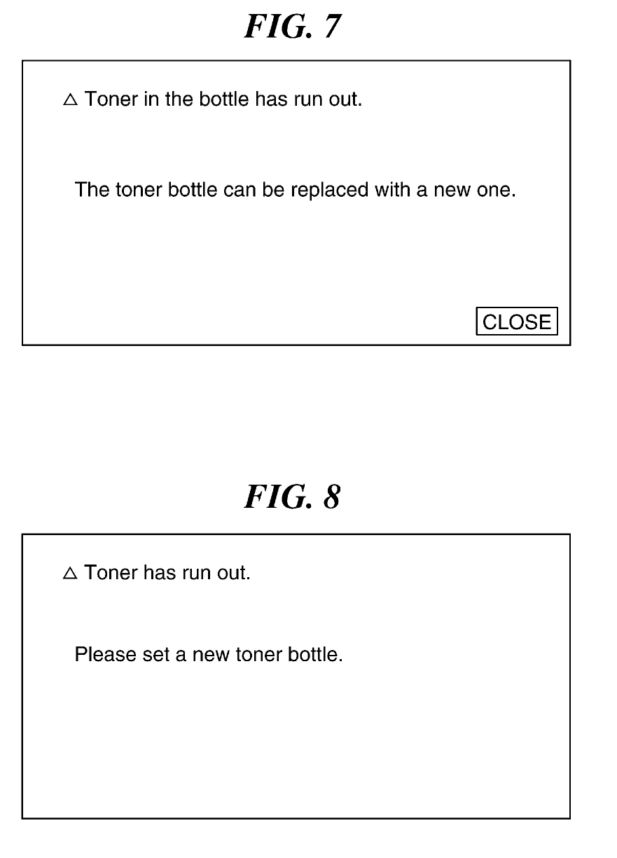

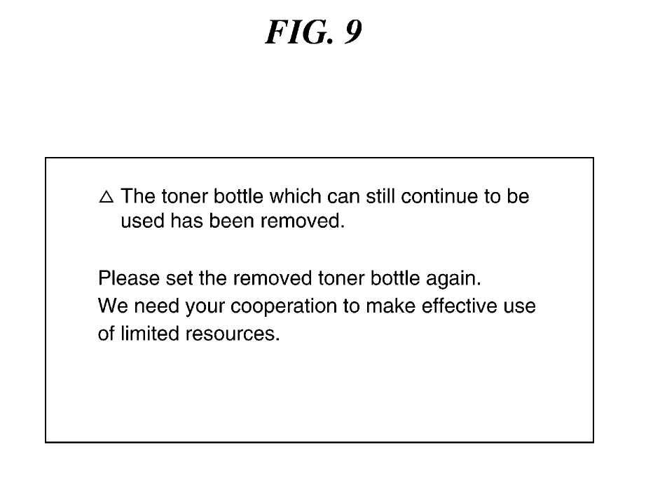

FIG. 7 is a diagram showing an example of a replaceable state-notifying screen. This replaceable state-notifying screen (third screen) is displayed on the touch panel of the console section 300 in a case where it is determined that toner in the toner bottle T has run out. By displaying this replaceable state-notifying screen, the user is notified that toner in the toner bottle T has run out, and that the toner bottle T can be replaced by a new toner bottle T. The user can replace the toner bottle T even when image formation continues to be performed (this is referred to as continuous run). When the user presses a “close” button on the replaceable state-notifying screen, the CPU 400 closes the replaceable state-notifying screen on the touch panel, and displays the home screen instead. The home screen is a screen different from the replacement prompting screen (see FIG. 8) and the warning screen (see FIG. 9), described hereinafter. On the home screen, the user can change print settings of the image forming apparatus 100, and, for example, can make settings of the number of prints, the image density of printed matter, and a printing mode. Therefore, even when absence of toner in the toner bottle T is determined, the user can make a setting of the printing mode from the home screen, insofar as toner remains in the toner conveying path 210.

FIG. 8 is a diagram showing an example of the replacement prompting screen. This replacement prompting screen (first screen) is displayed on the touch panel of the console section 300 in a case where absence of toner in the toner conveying path 210 is determined. By displaying this replacement prompting screen, the user is notified that toner in the toner bottle T has run out, and that it is necessary to replace the toner bottle T with a new toner bottle T. This notification prompts the user to replace the toner bottle T. The user takes out (removes) the toner bottle T from the image forming apparatus 100, and mounts a new toner bottle T. After it is detected by the bottle sensor 203 that the toner bottle T has been removed, if it is detected by the bottle sensor 203 that a toner bottle T is mounted, the CPU 400 closes the replacement prompting screen, and displays the home screen instead.

Note that immediately after the toner bottle T is replaced while the replacement prompting screen is displayed, usually, there is no toner in the toner conveying path 210 and there is less than the predetermined amount (reference amount) of toner in the developing device 140. Therefore, first, the CPU 400 controls the bottle motor 201 so as to perform toner replenishment from the toner bottle T to the toner conveying path 210. Then, when the output from the second toner sensor 213 comes to indicate the detection result of presence of toner in the toner conveying path 210, the CPU 400 controls the conveying path motor 211 so as to start toner replenishment from the toner conveying path 210 to the developing device 140. After that, when presence of toner in the developing device 140 is determined, the image forming apparatus 100 is enabled to perform the image forming operation.

FIG. 9 is a diagram showing an example of the warning screen. This warning screen (second screen) is a screen indicating that the removed toner bottle T can still be used. If the toner bottle T is removed before it is determined, based on the above-described processing for determining absence of toner in the toner bottle T (see FIG. 6A), that toner in the toner bottle T has run out, there is a fear that the removed toner bottle T is disposed as it is. To eliminate this inconvenience, the CPU 400 displays the warning screen on the touch panel of the console section 300, in the case where the bottle sensor 203 has detected removal of the toner bottle T in a state in which toner remains in the toner bottle T. The warning screen displays a message for prompting the user to remount the removed toner bottle T. This makes it possible to prevent the user from erroneously removing and disposing the toner bottle T which need not be replaced.

When the user remounts the toner bottle T, the CPU 400 closes the warning screen on the touch panel, and displays the home screen instead. Therefore, in a case where the bottle sensor 203 detected mounting of the toner bottle T while the warning screen is displayed, the home screen is displayed on the touch panel of the console section 300. Note that in the case where the warning screen is displayed, even when a predetermined time period elapses without any user's operation on the touch panel, the image forming apparatus 100 is not shifted to the low power mode in which the brightness of the touch panel is reduced. In other words, in the state in which the warning screen is not displayed on the console section 300, the CPU 400 reduces the brightness of the console section 300 when the predetermined time period elapses without any operation on the console section 300. However, in the state in which the warning screen is displayed on the console section 300, the CPU 400 controls the brightness of the console section 300 such that it is not reduced even after the predetermined time period elapses without any operation on the console section 300. This makes it easy for the user to notice the display of the warning screen even when the image forming apparatus is not used for some time.

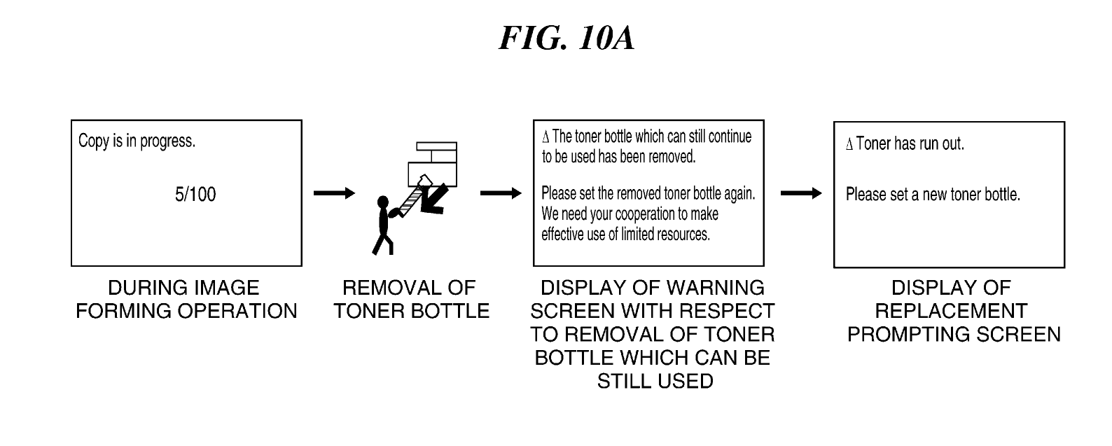

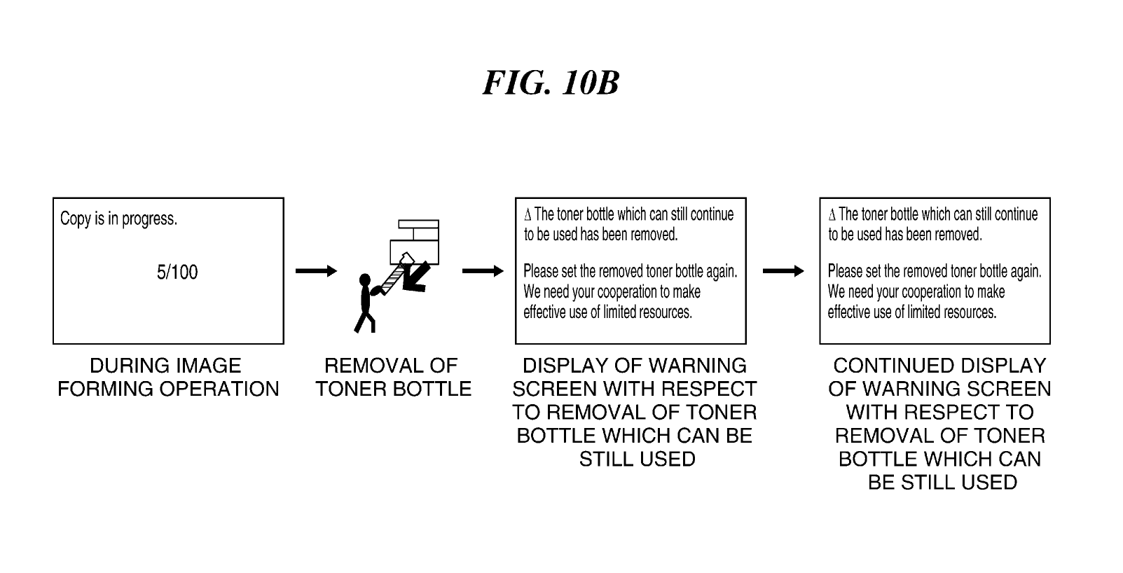

Next, a description will be given of changes of display of the screen on the console section 300 in a case where the toner bottle T which is not empty has been removed, and thereafter, image formation is continued in this state, with reference to FIGS. 10A and 10B. FIGS. 10A and 10B are diagrams showing changes of the screen in a conventional image forming apparatus and the image forming apparatus according to the present embodiment, respectively.

First, in both of the conventional image forming apparatus and the image forming apparatus according to the present embodiment, when a user removes the toner bottle T before the toner bottle T becomes empty during the image forming operation, the warning screen (see FIG. 9) is displayed (see FIGS. 10A and 10B). In the case of the conventional image forming apparatus, after that, if the user does not attach the toner bottle T as prompted by the warning screen, the continued image formation eventually results in determination of absence of toner in the toner conveying path 210, and the replacement prompting screen (see FIG. 8) is displayed. At this time, the replacement prompting screen is displayed in a manner superimposed on the warning screen, which prevents the user from visually recognizing the warning screen. As a result, the user may erroneously mount not the toner bottle T which has been removed once, but a new toner bottle T, according to the replacement prompting screen.

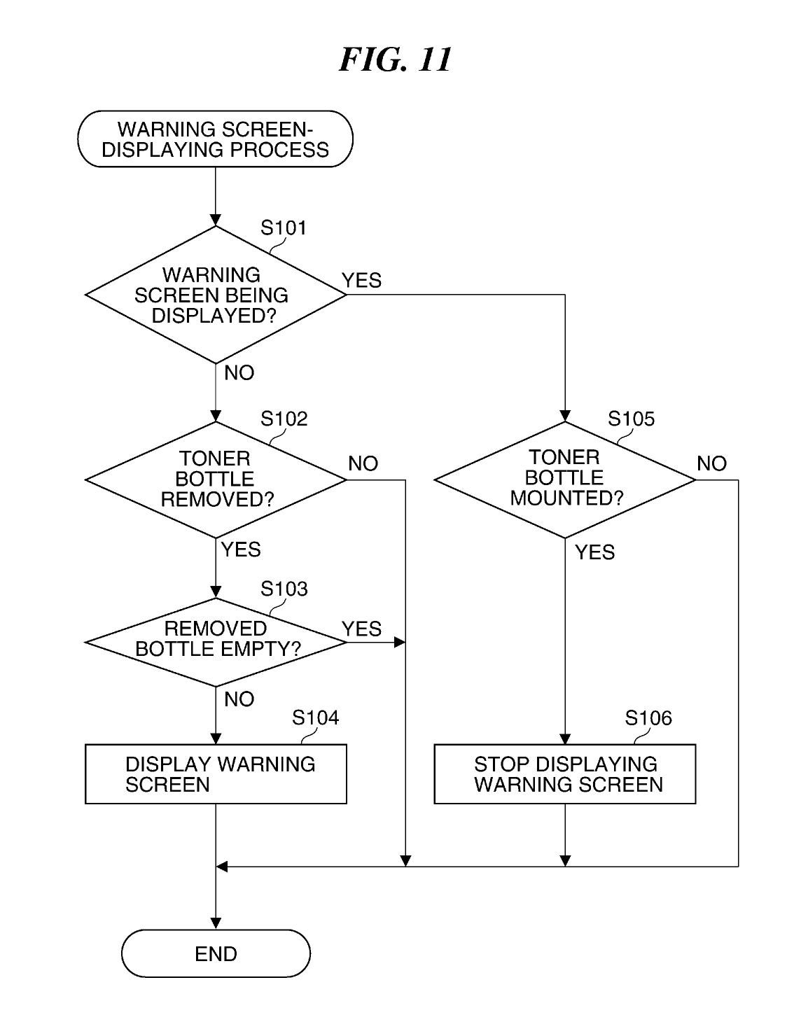

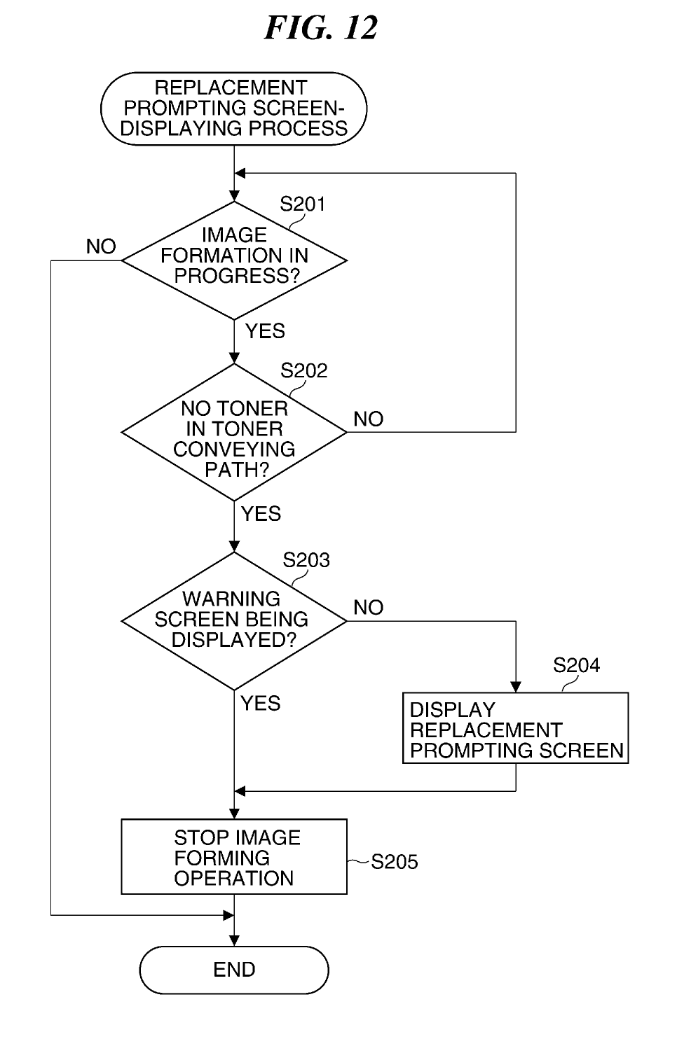

In contrast, in the image forming apparatus according to the present embodiment, as shown in FIG. 10B, after the warning screen is displayed, even if the user does not mount the toner bottle T as prompted by the warning screen, and the continued image formation eventually results in determination of absence of toner in the toner conveying path 210, the replacement prompting screen is not displayed. That is, if absence of toner in the toner conveying path 210 is determined, the CPU 400 stops the image forming operation, but continues to display the warning screen without displaying the replacement prompting screen. This makes it possible to maintain a state in which the warning screen is visible to the user, and continue to prompt the user to remount the toner bottle T which has been removed once. Processes for realizing the changes of the screen as shown in FIG. 10B will be described with reference to FIGS. 11 and 12. In the processes shown in FIGS. 11 and 12, the CPU 400 functions as a display and a determination unit of the present invention.

FIG. 11 is a flowchart of a warning screen-displaying process as one of the above-mentioned processes. The warning screen-displaying process is realized by the CPU 400 that loads an associated program stored in the ROM 401 into the RAM 402, and executes the same. The CPU 400 executes the warning screen-displaying process at intervals of e.g. 500 msec irrespective of the state of the image forming operation. Note that after the main power of the image forming apparatus 100 is turned on, the CPU 400 acquires the replenishment information recorded in the memory 223 of the toner bottle T, by using the reading section 204, and stores the acquired replenishment information in the RAM 402.

In a step S101, the CPU 400 determines whether or not the warning screen (see FIG. 9) is being displayed on the console section 300. Then, if the warning screen is being displayed, the CPU 400 proceeds to a step S105, whereas if the warning screen is not being displayed, the CPU 400 proceeds to a step S102. In the step S102, the CPU 400 determines, based on a result of the detection performed by the bottle sensor 203, whether or not the toner bottle T has been removed, and if it is determined that the toner bottle T has not been removed, the present process is terminated. On the other hand, if it is determined that the toner bottle T has been removed, the CPU 400 determines in the step S103, based on the above-described processing for determining absence of toner in the toner bottle T, whether or not the removed toner bottle T is empty (see FIG. 6A). Then, if the removed toner bottle T is empty, the CPU 400 terminates the present process. On the other hand, if the removed toner bottle T is not empty, in a step S104, the CPU 400 displays the warning screen (see FIG. 9) on the console section 300, followed by terminating the present process.

In the step S105, the CPU 400 determines, based on a result of the detection performed by the bottle sensor 203, whether or not a toner bottle T (which is not necessarily the one which has been removed once) is mounted. Then, if no toner bottle T is mounted, the CPU 400 terminates the present process. On the other hand, if a toner bottle T is mounted, the CPU 400 stops displaying (closes) the warning screen in a step S106, followed by terminating the present process The display screen shifts to the home screen.

According to the warning screen-displaying process in FIG. 11, when a user erroneously removed the toner bottle T before toner in the toner bottle T runs out, the warning screen (see FIG. 9) is displayed, which enables the user to notice that replacement of the toner bottle T is not required.

FIG. 12 is a flowchart of a replacement prompting screen-displaying process. This replacement prompting screen-displaying process is realized by the CPU 400 that loads an associated program stored in the ROM 401 into the RAM 402, and executes the same. The CPU 400 starts the present process when the image forming operation is started.

First, in a step S201, the CPU 400 determines whether or not the image forming operation is being performed, and if the image forming operation is not being performed, the CPU 400 terminates the present process. On the other hand, if the image forming operation is being performed, in a step S202, the CPU 400 determines, based on the above-described processing for determining absence of toner in the toner conveying path 210, whether or not there is no toner in the toner conveying path 210 (see FIG. 6B). Then, if toner remains in the toner conveying path 210, the CPU 400 returns to the step S201. With this, even when it is determined that there is no toner in the toner bottle T, the image formation is not stopped until it is determined that there is no toner in the toner conveying path 210 (more specifically that the amount of developer in the developing device is smaller than the predetermined amount). Further, if it is determined, during repetition of execution of the steps S201 and S202 in FIG. 12, that there is no toner in the toner bottle T, the replaceable state-notifying screen (third screen; FIG. 7) is displayed. This enables the user to replace the toner bottle T even when the image forming apparatus is performing the image forming operation.

On the other hand, if there is no toner in the toner conveying path 210 (the amount of developer in the developing device is smaller than the predetermined amount), in a step S203, the CPU 400 determines whether or not the warning screen (see FIG. 9) is being displayed on the console section 300. Then, if the warning screen is not being displayed, in a step S204, the CPU 400 displays the replacement prompting screen (see FIG. 8), and proceeds to a step S205. In the step S205, the CPU 400 stops the image forming operation, followed by terminating the present process. On the other hand, if it is determined in the step S203 that the warning screen is being displayed, the CPU 400 directly proceeds to the step S205. That is, the CPU 400 prevents the replacement prompting screen (see FIG. 8) from being displayed. With this, the visible state of the warning screen (see FIG. 9) is maintained.

As described above, in a case where the toner bottle T, which has not become empty yet, is removed, and even when toner in the toner conveying path 210 runs out in the state in which the warning screen is displayed, the CPU 400 continues to display the warning screen without displaying the replacement prompting screen.

According to the present embodiment, the replacement prompting screen (first screen; FIG. 8) is displayed according to determination of absence of toner in the toner conveying path 210. Further, the warning screen (second screen; FIG. 9) is displayed upon detection of removal of the toner bottle T in which toner still remains. Even in a case where absence of toner in the toner conveying path 210 is determined, insofar as the warning screen is displayed, the replacement prompting screen is not displayed, and the visible state of the warning screen is maintained. This makes it possible to continuously prompt the user to continue to use the toner bottle T which has been removed in a state still containing toner, even after toner in the toner conveying path 210 as the buffer runs out. Therefore, it is possible to prevent a situation in which a user erroneously replaces the toner bottle T in which toner remains with a new toner bottle T.

Note that, in the present embodiment, even if toner in the toner conveying path 210 runs out while the warning screen is displayed, the visible state of the warning screen is maintained by preventing the replacement prompting screen from being displayed. However, what is required is to prevent recognition of the information to be notified by the warning screen from being obstructed, and hence the method of maintaining the visible state of the warning screen is not limited to the above-described example. For example, by making the priority level of the warning screen higher than the replacement prompting screen, the replacement prompting screen may be displayed under the warning screen (reverse side) such that the warning screen overlaps the replacement prompting screen, or may be displayed in a different area from the warning screen. Even when the warning screen and the replacement prompting screen partially overlap each other, it is only required to maintain the visible state of the warning screen to such an extent that the purpose of notification using the warning screen is achieved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-188361 filed Sep. 28, 2017, which is hereby incorporated by reference herein in its entirety.

What is claimed is:

1. An image forming apparatus comprising:
an image forming unit including a developing device that contains developer and configured to form an image using the developer in the developing device;
a portion to which a container is mountable, the container containing developer to be replenished to the developing device;
a replenishment unit configured to replenish developer in the developing device from the container mounted to the portion;
a sensor that detects an amount of the developer in the developing device;
a display configured to display a first screen for prompting a user to replace the container mounted to the portion, in a case where an amount of the developer, detected by the sensor, is smaller than a predetermined amount; and
a determination unit configured to determine whether or not the container mounted to the portion satisfies a replacement condition,
wherein in a case where the container mounted to the portion is removed while the replacement condition is not satisfied, the display displays a second screen for prompting the user to remount the removed container, and
wherein in a case where the amount of the developer, detected by the sensor, is smaller than the predetermined amount while the second screen is displayed, the display continues to display the second screen.

2. The image forming apparatus according to claim 1, wherein in the case where the amount of the developer, detected by the sensor, is smaller than the predetermined amount while the second screen is displayed, the display prevents the first screen from being displayed.

3. The image forming apparatus according to claim 1, wherein in the case where the amount of the developer, detected by the sensor, is smaller than the predetermined amount while the second screen is displayed, the display displays the first screen in such a manner that the visible state of the second screen is not obstructed.

4. The image forming apparatus according to claim 1, further comprising a controller configured to control the image forming unit so as not to cause the image forming unit to stop image formation, until it is determined that the amount of the developer is smaller than the predetermined amount, even after it is determined that the replacement condition is satisfied.

5. The image forming apparatus according to claim 4, wherein in a case where it is determined that the replacement condition is satisfied while it is not determined that the amount of the developer is smaller than the predetermined amount, the display displays a third screen indicating that the container can be replaced.

6. The image forming apparatus according to claim 1, wherein in a case where the amount of the developer becomes smaller than the predetermined amount, if an output from the sensor does not change even after a predetermined replenishment operation for replenishing the developer from the mounted container to the developing device is performed by the replenishment unit, the determination unit determines that the replacement condition is satisfied.

7. The image forming apparatus according to claim 1, wherein in a state in which the second screen is not displayed, the display reduces brightness of the display on condition that a predetermined time period elapses without any operation on the display, whereas in a state in which the second screen is displayed, the display does not reduce the brightness of the display even after the predetermined time period elapses without any operation on the display.
